(19) United States
(12) Patent Application Publication
(10) Pub. No.: US 2016/0156248 A1
(43) Pub. Date: Jun. 2, 2016

(54) Low Profile Motor

(71) Applicant: David Lueker, Glendale, AZ (US)

(72) Inventor: David Lueker, Glendale, AZ (US)

(21) Appl. No.: 14/556,944

(22) Filed: Dec. 1, 2014

(51) Int. Cl. H02K 7/116; E06B 9/68; F16H 1/46; H02K 7/102

(52) U.S. Cl. CPC H02K 7/116; H02K 7/1025; E06B 9/68; F16H 1/46

(57) ABSTRACT

The present disclosure includes a system and article of manufacture for a low profile motor. The low profile motor can include a motor housing, a hub, an annular gear train encircling the hub, a rotor encircling the annular gear train, and a stator encircling the rotor. The orientation of the hub, the annular gear train, the rotor, and the stator is concentric, providing a low profile motor assembly with various benefits such as higher torques and advantageous braking. The gear trains that are efficient, reduce the profile or overall volume of the motor assembly, and reduce torsional reactions and coaxial shifting. Such motor assemblies may also have gear trains that more effectively distribute the load in the gear train and thus, torque capability.

### BACKGROUND

1. Field

The present disclosure generally relates to motors. More particularly, the present disclosure relates to low profile electric motors suitable for use with rollup doors.

2. Related Art

A variety of electric motor and gear options are used in connection with commercial applications, such as in the field of rollup doors, which are widely used for industrial and commercial purposes. For example, rollup doors are commonly used as cargo bay doors, self-storage unit doors, garage doors, and the like. Rollup doors often comprise a number of interconnected leaves or slats, and this group of interconnected slats may comprise a “door curtain” or “curtain” and based on their size and the materials used, can be quite heavy. The curtain may be mounted to an overhead shaft, and as the rollup door is opened, or rolled up, the curtain may wind in layers about the shaft.

Often the door curtains are rolled up (retracted) or down (deployed) using electric motors with various gear trains connected to the door curtain shaft. There are generally two common configurations for door operators. The first type includes standard parallel axis gear trains connected to the door shaft with the use of a chain and sprockets or a belt and pulleys. The second type includes right angle gear trains, typically a worm gear set, connected directly to the door curtain shaft. The size and weight of the door curtains can exert significant torque on the door curtain shafts, the power output shafts, and the gear trains of the motors used to roll and unroll the door curtains. Similarly, the braking systems needed to slow and stop the door curtains encounter significant forces by virtue of the size and weight of the curtains.

Accordingly, electric motors with gearing systems which facilitate high torque and advantageous braking are desirable. Similarly, gear trains that are efficient, and reduce the profile (volume), torsional reactions, and coaxial shafting are desirable. Further still, gear trains that more effectively distribute the load in a gear train and thus, torque capability, is desirable.

### SUMMARY

The present disclosure includes a system and article of manufacture for a low profile motor which may be used in connection with numerous applications, such as for rolling and unrolling a door curtain. Among other aspects, low profile electric motor assemblies in accordance with the present disclosure may include a motor housing having an annular gear train encircling a hub, a rotor encircling the annular gear train, and a stator encircling the rotor. The hub, the annular gear train, the rotor, and the stator are oriented concentrically, in a low profile manner.

In various embodiments, the annular gear train includes one or more ring gears that receive power from the rotor, two or more planetary gears, one or more sun gears, and a variety of gear carriers that transfer power from the motor to the hub, which is thus transferred to an output shaft which may be used to retract and deploy a door curtain such as described herein. In various embodiments, various configurations of one or more brakes may be used to slow and/or stop the rotation of the motor assemblies described herein.

### BRIEF DESCRIPTION OF THE DRAWINGS

The features and advantages of the present disclosure will become more apparent from the detailed description set forth below when taken in conjunction with the drawings.

FIG. 1 shows a cross-sectional side view of a motor assembly orientation in accordance with the present disclosure;

FIG. 2 shows a perspective view of a motor assembly with an annular gear train, a rotor, and a stator in accordance with the present disclosure;

FIG. 3 shows a cross-sectional front view of a motor assembly with a shaft, a hub, an annular gear train, a rotor, a stator and a housing in accordance with the present disclosure;

FIG. 4a shows a perspective view of a closed door curtain assembly with an attached motor assembly in accordance with the present disclosure;

FIG. 4b shows a perspective view of a closed door curtain assembly with an unattached motor assembly in accordance with the present disclosure;

FIG. 5a shows a close-up front view of a door curtain assembly proximate to an attached motor assembly in accordance with the present disclosure; and

FIG. 5b shows a close-up side view of a motor assembly attached to a door curtain assembly in accordance with the present disclosure.

### DETAILED DESCRIPTION

The detailed description herein makes reference to the accompanying drawings, which show various aspects by way of illustration and their best mode. While these aspects are described in sufficient detail to enable those skilled in the art to practice the disclosure, it should be understood that other aspects may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Furthermore, any reference to singular includes plural aspects, and any reference to more than one component may include a singular aspect.

While the specific aspects of the present disclosure will be described in greater detail below, in general, motor assemblies in accordance with the present disclosure comprise a motor, for example, an electric motor, having a gearing system which facilitates high torque and advantageous braking. Motor assemblies in accordance with the present disclosure are used with gear trains that are efficient, reduce the profile or overall volume of the motor assembly, and reduce torsional reactions and coaxial shifting. Motor assemblies in accordance with the present disclosure may also have gear trains that more effectively distribute the load in the gear train and thus, torque capability.

Additionally, in various embodiments, the various elements described herein may be manufactured of now known or as yet unknown materials suitable for applications such as rollup doors and the like. For example, various metals and metal allows commonly used in gear systems and transmissions are suitable, though other materials having suitable physical properties such as ceramics and advanced composites and polymers may likewise fall within the scope of the present disclosure. For example, exemplary materials include various stainless steels, magnesium, titanium, chrome-moly, and the like. Similarly, the gears, shafts, bearings and related structure disclosed herein may likewise be configured with materials, dimensions and specifications, as well as lubrications, fasteners, and the like known in the art, or as yet unknown.

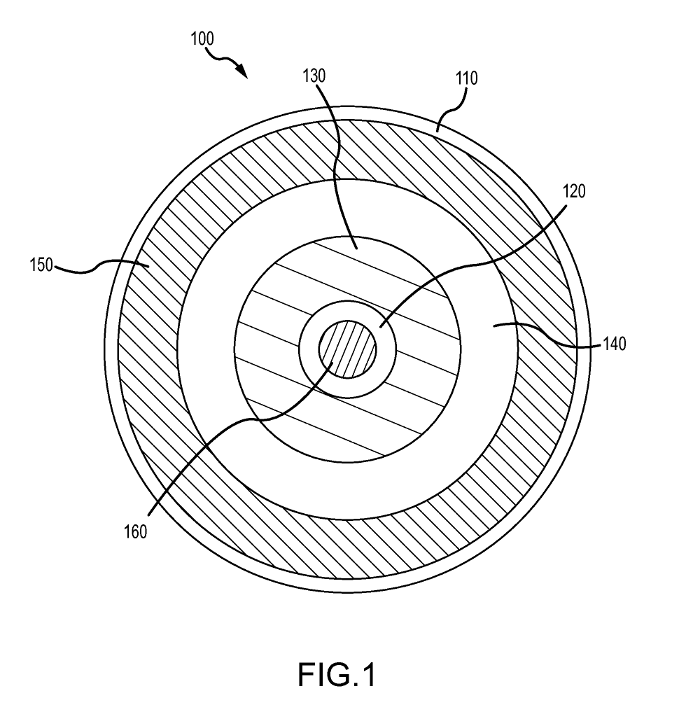

With reference now to FIG. 1, a low profile electric motor assembly 100 in accordance with the present disclosure includes a motor housing 110, a hub 120, an annular gear train 130 encircling the hub 120, a rotor 140 encircling the annular gear train 130, and a stator 150 encircling the rotor 140. In various accordance with various aspects, the hub 120, the annular gear train 130, the rotor 140, and the stator 150 are oriented concentrically in a low profile orientation and share the same axis. In this respect, as used herein “low profile” means a shortened axial length (measured along an output shaft 160 of the motor assembly 100) relative to a radius of the motor assembly measured from the center of the output shaft 160 to an outer surface of the stator 150. As used herein, “stator” (typically, a magnet) and “rotor” (typically having conductive windings and/or field coils) mean, respectively, the stationary and moving portions of electric motors, that move relative to one another when the rotor 140 is energized.

In accordance with various aspects of the present disclosure, the motor assembly 100 may have a generally large rotor 140 and stator 150 diameter that beneficially adds length to the torque lever of the motor assembly 100. For example, the radius of the inner diameter of rotor 140 to the outer diameter of the stator 150 may range from about 12 inches to about 20 inches, though these dimensions may vary based on the particular application. Likewise, the size (axial width) of the rotor 140 and stator 150 may each vary.

In accordance with various aspects of the present disclosure, a 12 pole motor may be used to increase the torque of the motor assembly 100 and reduce the output speed of the motor assembly 100, thereby requiring less gear reduction to drive a rolling steel door at typical speeds, such as about 24 inches per second.

With respect now specifically to the hub 120, the size of the hub 120 is suitably selected to transmit torque at or near a 100 percent torsional mode to decrease the transfer of bending stresses to the output shaft 160. For example, in accordance with one embodiment of the present disclosure, the output shaft 160 has a diameter of 2 inches and is manufactured from 1018 steel providing an ultimate strength of about 63.8 ksi and a 0.29 multiplier for a nearly infinite life through torsional loading. In various embodiments, the hub 120 may have a keyway for standard 2 inch shafts so that legacy products may be used with the embodiments described herein.

As will be described in more detail herein, in various embodiments, the annular gear train 130 can be an epicyclic gear train having at least two gears mounted such that the center of one gear revolves around the center of the other. A carrier connects the centers of the gears and rotates to carry one gear or gears (referred to herein as a “planetary gear” or “planetary gears”) around the other gear (referred to herein as a “sun gear”). The planetary gears and sun gear have “teeth” that mesh so that they rotate without slipping. The annular gear train 130 further includes an outer “ring gear” (also having teeth) and the planetary gears roll on the inside of the ring gear. Because the planetary gears engage both the sun gear and the ring gear, by locking (prohibiting rotation of) various combinations of the rotation the gears and carriers, the gear ratios and corresponding torque and speed can be changed.

As will be described below, motor assemblies with annular gear trains 130 as described herein provide higher power density relative to standard parallel axis gear trains and worm gear trains. Because the load in such annular gear trains 130 are shared with a planetary gear set having among multiple planetary gears 180, torque capability is increased, and as the number of planetary gears 180 is increased, so too is the load ability and ability receive higher torque loads. Additionally, the planetary gears 180 provide stability due to an even distribution of mass and increased rotational stiffness, and torque applied radially to the planetary gears 180 is transferred radially by each planetary gear 180, without lateral pressure on the gear teeth. In accordance with various aspects of the embodiments described herein, an annular gear train 130 within the rotor 140 can be used to reduce output speed.

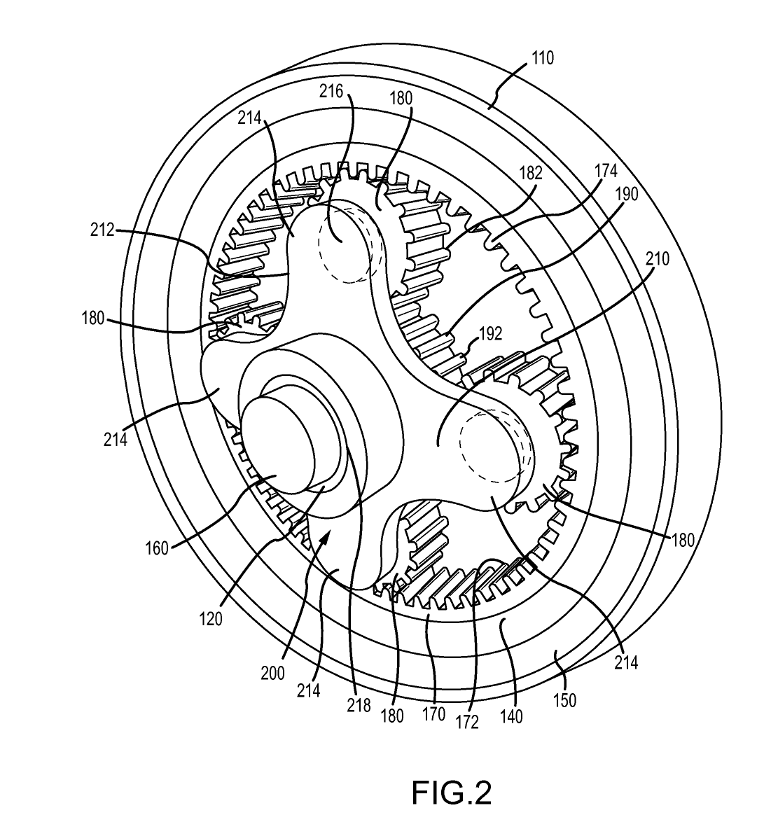

With specific reference now to FIG. 2, in accordance with various aspects of the present disclosure, the annular gear train 130 comprises a first ring gear 170 that receives power from the rotor 140. Within the ring gear 170 are two or more planetary gears 180 that engage an inner surface 172 of the first ring gear 170 and transfer power from the first ring gear 170 by rotation of the first ring gear by rotor 140. In FIG. 2, four planetary gears 180 are illustrated, but it should be appreciated that varying numbers of planetary gears 180 may be substituted within the scope of the present disclosure depending on the application.

With continued reference to FIG. 2, the annular gear train 130 includes a first sun gear 190 that receives power from the planetary gears 180 via engagement between an outer surface 192 of the first sun gear 190 and the planetary gears 180. In accordance with various aspects of the present disclosure, the hub 120 is rotationally affixed to the first sun gear 190 to transfer power from the first sun gear 190 (and thus, from the annular gear train 120) to an output shaft 160 may also be provided.

In various embodiments, and as described in more detail below, the low profile electric motor assembly 100 further comprises a planetary gear carrier 200 which can be locked, along the planetary gears 180, in position about the axis of the annular gear train 130 (and thus, the axis of the rotor 140, stator 150, carrier 200, ring gear 170, and sun gear 190), yet still allow rotation of the planetary gears 180 about their own axis. Alternatively, locking rotation of the planetary gears 180 about each gear's respective axis, but allowing the carrier 200, to rotate about the axis of the annular gear train 130, allows each planetary gear 180 to “orbit” the axis of the annular gear train 130. The carrier 120 can also assist in maintaining the planetary gears 180 in the proper axial orientation with respect to the first ring gear 170 and the first sun gear 190, and may additionally provide increased stability, strength and resistance to vibration.

In accordance with various aspects of the present disclosure, and with continued reference to FIG. 2, the planetary gear carrier 200 comprises a carrier frame 212. Carrier frame comprises carrier arms 214 extending from a generally central portion of the carrier frame. In accordance with the illustrated embodiment, each arm 214 has a planetary gear shaft 216 on which each planetary gear is mounted and can freely rotate or can be locked in place. Carrier frame 212 has a center aperture 218, through which the output shaft 160 and/or the hub 120 may extend, such that output shaft 160 and/or hub 120 may rotate freely with respect to the carrier 210. As noted above, as the number of planetary gears 180 varies, the number of arms 214 may likewise vary.

In accordance with the embodiment described in FIG. 2, rotor 140 is affixed to the first ring gear 170 of the annular gear train 130. The inner surface 172 of the first ring gear 170 has ring gear teeth 174 that engage planetary gear teeth 182 on planetary gears 180. On a side of each planetary gear 180 opposite the side of planetary gear 180 that engages the first ring gear 170, each planetary gear 180 engages sun gear teeth 192 on the centrally located first sun gear 190.

In operation, a low profile electric motor assembly 100 in accordance with the present disclosure operates as follows. When the windings of rotor 140 are energized, for example by application of an alternating current (AC) or direct current (DC), as with a conventional electric motor, it interacts with the magnets of the stator 150 so that the rotor moves (rotates). The rotor is affixed to the annular gear train 130, thus rotating the outer circumference of the gear train 130 and thereby transferring the rotational motion the annular gear train 130 (and variously changes the torque and speed ratios as desired) to the hub 120, which in turn transfer the rotational motion to the output shaft 160.

More specifically, with reference to FIG. 2, when energized, the rotor 140 begins rotating and thus rotates the first ring gear 180. As noted above, by locking (prohibiting rotation) various combinations of the rotation of the gears and carrier (or carriers if there are more than one), the gear ratios and corresponding torque and speed can be changed. For example, where the carrier 200 is locked (prohibited from rotating about its axis) and the planetary gears 180 can rotate freely about their respective axis, the rotational motion of the first ring gear 180 is translated into rotational motion of each planetary gear 180 about its planetary gear shaft 216 (which is mounted on the planetary gear carrier 200). The subsequent rotation of the planetary gears 180 is thus translated into rotational motion of the first sun gear 190 about its axis. The first sun gear is rotationally affixed to the output shaft 160 or may be affixed to the hub 120, which is in turn affixed to the output shaft 160, and in either case, provides power to the output shaft 160 at a particular ratio.

Alternatively, if rotation of the planetary gears 180 about their respective axis is locked and the carrier 200 is permitted to rotate about its axis, the rotational motion of the first ring gear 180 causes the planetary gears to rotate about the axis of the annular gear train 130 in an orbit, and because the planetary gears 180 cannot rotate, their orbit is translated into rotational motion the first sun gear 190 about its axis. Again, because the first sun gear is rotationally affixed to the output shaft 160 or the hub 120, which is in turn affixed to the output shaft 160, power to the output shaft 160 is provided at another gear ratio.

As one skilled in the art will appreciate, an annular gear train 130 in accordance with various embodiments multiple sets of gears and carriers, including those described above, with various configurations and orientations.

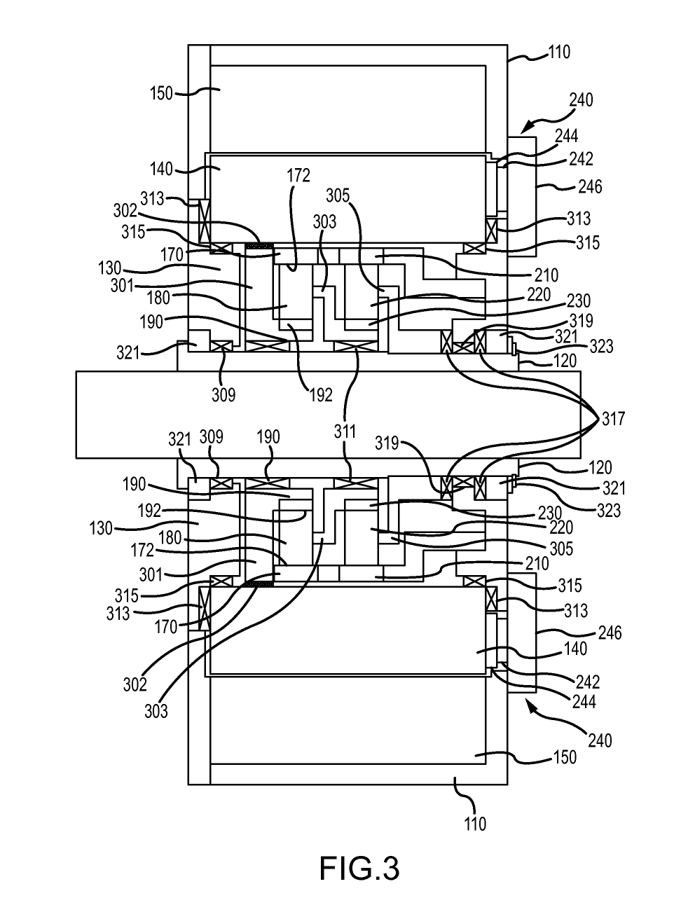

For example, with reference now to FIG. 3, the annular gear train 130 may comprise a second ring gear 210, a second planetary gear set comprised of two or more second planetary gears 220, and a second sun gear 230 that receives power from the second planetary gears 220. As described below, the annular gear train 130 may further comprise a first sun carrier 301, first planet carrier 303, and a second planet carrier 305. As one skilled in the art will appreciate, third, fourth and more additional sets of gears may also be implemented in accordance with the aspects described in the present disclosure. In the presently described embodiment, by virtue of having two full gear sets, up to four annular gear train 130 speeds may be provided by locking and unlocking various combinations of the gears and carriers. Such locking and unlocking may be suitably provided by conventional clutch and solenoid mechanisms, as well as other mechanisms now known or as yet unknown.

In various embodiments, various bearing surfaces, seals, washers, retaining rings, and similar components to facilitate the operation of the motor 100 and extend the life. For example, hub bearings 309, planetary bearings 311, rotor thrust bearings 313, rotor bearings 315, hub thrust bearings 317, and hub bearings 319 may be provided as bearing surface for the various components of the motor 100 and the annular ring gear 130.

Likewise, various seals such as shaft seals 321 may be provided to, for example, keep contaminants out of the motor 100 and the annular ring gear 130, and to keep system lubricants within. Retaining rings 323, such as conventional snap rings, may be provided to facilitate keeping various components in place.

With continuing reference to FIG. 3, when energized, the rotor 140 begins rotating and being affixed to the first sun carrier 301 at rotor connection point 302, the rotation of the rotor 140 rotates the first sun gear 190. In the presently described embodiment, the first ring gear 170 is locked, and thus, the rotation of the first sun gear 190 transfers rotation to the planetary gears 180, and thus, to first planet carrier 303. Rotation of the first planet carrier 303 is thus transferred to the second sun gear 230. In this embodiment, the second ring gear 210, like the first ring gear 170, is locked, and thus rotation is thus transferred to the second planet carrier 305, which is affixed to the hub 120 and/or door shaft 160.

Similar to the description above, by locking various combinations of the gears and carriers, the gear ratios and corresponding torque and speed can be changed. In this regard, the annular gear train 130 can provide a preselected gear reduction. For example, in one embodiment, each planetary gear 180 can provide a gear reduction of about 5:1 maximum, so each planetary gear can provide a reduction of approximately 4.5:1, and thus an overall 20:1 reduction may be obtained.

In accordance with various aspects of the present disclosure, a motor assembly 100 may include one or more brakes. For example, with reference to FIG. 3, motor assembly includes a brake 240. As shown in FIG. 3, the brake 240 can be located on an end of the rotor 140 in a “disc brake” configuration. Alternatively, the brake 200 can be located on an outer circumferential surface of the rotor 140 in a “drum brake” configuration (not shown). Likewise, various numbers and combinations of brakes, now known or as yet unknown may be used in connection with the embodiments described herein. By placing the brake 240 placed at a large radius from the shaft, torque capacity is maximized. In this regard, a large diameter brake 240 lengthens the lever arm, thus reducing the required clamping load to achieve adequate holding power.

With continued reference to FIG. 3, the brake 240 includes a brake pad 242 which contacts a brake running surface 244 that is attached to the rotor 140. When braking of the motor assembly 100 is desired, as with conventionally known braking systems, a brake activation device 246 forces the brake pad 242 into contact with the brake running surface 244 to cause friction and slow rotation the of the rotor 140. In various embodiments, the brake activation device 246 may be a conventional solenoid, but in other embodiments may comprise other activation devices, such as hydraulic activation devices.

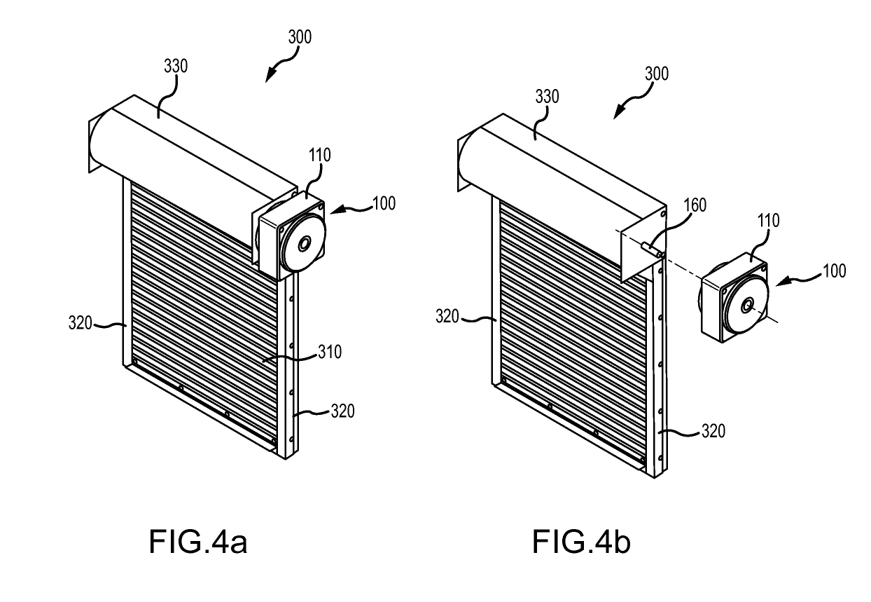

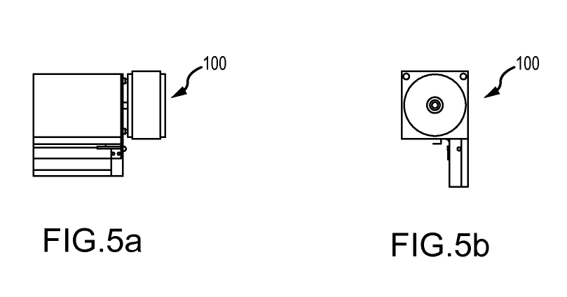

As noted above, motor assemblies in accordance with the present disclosure, may be used in connection with rollup doors such as cargo bay doors, self-storage unit doors, garage doors, and the like. For example, with reference now to FIG. 4a-b and FIG. 5a-b, a door curtain assembly 300 with a motor assembly 100 in accordance with the present disclosure is illustrated. The door curtain assembly 300 includes a conventional door curtain 310 which rolls onto a shaft, which maybe the output shaft 160 of the motor assembly 100. In some embodiments, the door curtain 310 may travel on a track 320 that is mounted to the structure to which the door curtain assembly 300 is affixed. As the door curtain 310 is rolled onto the output shaft 160, it may feed into a door curtain housing 330, and as the door curtain 310 is deployed from the output shaft 160, it exits the door curtain housing 330. Affixed to the door curtain through the output shaft 160 is the motor assembly 100, which is suitably mounted to the door curtain assembly 300 and/or another mounting structure such as a wall or frame around the door curtain 310.

The motor assembly 100 is as described above and includes the motor housing 110, the stator 150 and rotor 140, the annular gear train 130 (or transmission), the hub 120 for transferring power to the output shaft 160. As described above, the annular gear train 130 encircles the hub 120, the rotor 140 encircles the annular gear train 130, and the stator 150 encircles the rotor 140 and as such, the hub 120, the annular gear train 130, the rotor 140, and the stator 150 are oriented concentrically in a low profile orientation. When the motor assembly is activated, depending on the direction of rotation, the rotor 140, which is affixed to the annular gear train 130, rotates the outer circumference of the gear train 130 and thereby transfers the rotational motion to the annular gear train 130 (and changes the torque and speed ratios as desired) to the hub 120, which in turn transfers the rotational motion to the output shaft 160 causing the door curtain 310 to retract or deploy, based on the direction of rotation.

The detailed description herein makes reference to the accompanying drawings and pictures, which show various aspects by way of illustration and its best mode. While these aspects are described in sufficient detail to enable those skilled in the art to practice the disclosure, it should be understood that other aspects may be realized and that logical and mechanical changes may be made without departing from the spirit and scope of the disclosure. Thus, the detailed description herein is presented for purposes of illustration only and not of limitation. Further, any reference to singular includes plural aspects, and any reference to more than one component may include a singular aspects.

What is claimed is:

1. A low profile electric motor assembly comprising:
a motor housing;
a hub;
an annular gear train encircling the hub;
a rotor encircling the annular gear train; and
a stator encircling the rotor; and wherein the hub, the annular gear train, the rotor, and the stator are oriented concentrically.

2. The low profile electric motor assembly of claim 1, wherein the annular gear train further comprises:
a first ring gear that receives power from the rotor;
a first planetary gear that receives power from the first ring gear;
a first sun gear that receives power from the first planetary gear; and
wherein the sun gear provides power to the hub.

3. The low profile electric motor assembly of claim 1, further comprising an output shaft coupled to the hub.

4. The low profile electric motor assembly of claim 2, further comprising a planetary gear carrier.

5. The low profile electric motor assembly of claim 2, further comprising an output shaft coupled to the hub.

6. The low profile electric motor assembly of claim 1, further comprising a brake.

7. The low profile electric motor assembly of claim 8, wherein the brake is located on at least one of an end of the rotor and an outer circumferential surface of the rotor.

8. The low profile electric motor assembly of claim 6, wherein the brake is a solenoid brake.

9. The low profile electric motor assembly of claim 1, wherein the annular gear train provides a gear reduction of about 20:1.

10. A low profile electric motor assembly comprising:
a motor housing containing:
a hub;
a transmission encircling the hub;
a rotor encircling the a transmission,
a stator encircling the rotor;
wherein the transmission further comprises:
a first ring gear and a second ring gear;
a first sun gear and a second sun gear;
a first planetary gear set and a second planetary gear set, wherein the first planetary gear set is situated between the first ring gear and the first sun gear, and wherein the second planetary gear set is situated between the second ring gear and the second sun gear;
a first sun carrier connecting the rotor to the first sun gear;
a first planet carrier connecting the first sun gear to the first planetary gear set; and
a second planetary carrier connecting the first planetary gear set to the hub.

11. The low profile electric motor assembly of claim 10, wherein the transmission provides a gear reduction of about 20:1.

12. The low profile electric motor assembly of claim 10, further comprising an output shaft coupled to the hub.

13. The low profile electric motor assembly of claim 10, further comprising a brake.

14. The low profile electric motor assembly of claim 13, wherein the brake is located on at least one of an end of the rotor and an outer circumferential surface of the rotor.

15. A door curtain assembly with a low profile motor assembly comprising:
a door curtain affixed to a door curtain shaft;
a motor housing containing:
a hub connected to the shaft;
a transmission encircling the hub;
a rotor encircling the a transmission,
a stator encircling the rotor;
wherein the transmission further comprises:
a first ring gear and a second ring gear;
a first sun gear and a second sun gear;
a first planetary gear set and a second planetary gear set, wherein the first planetary gear set is situated between the first ring gear and the first sun gear, and wherein the second planetary gear set is situated between the second ring gear and the second sun gear;
a first sun carrier connecting the rotor to the first sun gear;
a first planet carrier connecting the first sun gear to the first planetary gear set; and
a second planetary carrier connecting the first planetary gear set to the hub.

16. The door curtain assembly with a low profile motor assembly of claim 15, further comprising a brake located on at least one of an end of the rotor and an outer circumferential surface of the rotor.

17. The door curtain assembly with a low profile motor assembly of claim 15, further comprising a door curtain housing.

18. The low profile electric motor assembly of claim 15, wherein the first ring gear is locked.

19. The low profile electric motor assembly of claim 15, wherein the second ring gear is locked.

20. The low profile electric motor assembly of claim 15, wherein the transmission provides a gear reduction of about 20:1.
